(19) United States
(12) Patent Application Publication
(10) Pub. No.: US 2008/0309057 A1
(43) Pub. Date: Dec. 18, 2008

(54) Combustion Chamber and Method for Production Thereof

(75) Inventors: Walter Richter, Simbach am Inn (DE); Stefan Malm, Melsungen (DE)

Correspondence Address: CROWELL & MORING LLP;INTELLECTUAL PROPERTY GROUP, P.O. BOX 14300, WASHINGTON, DC, 20044-4300, US

(73) Assignee: Neumayer Tekfor Holding GmbH, Hausach (DE)

(21) Appl. No.: 12/047,424

(22) Filed: Mar. 13, 2008

Related U.S. Application Data
(63) Continuation of application No. PCT/DE2006/001579, filed on Sep. 11, 2006.

(30) Foreign Application Priority Data
Sep. 13, 2005 (DE) 10 2005 043.767.2
Feb. 24, 2006 (DE) 10 2006 008 581.7
Jul. 21, 2006 (DE) 10 2006 034 285.2

(51) Int. Cl. B60R 21/264; B23P 13/04

(52) U.S. Cl. 280/741; 29/557

(57) ABSTRACT

A combustion chamber, particularly for airbags, with a barrel shaped body to which an ignition chamber is attached and which has a transition opening between the ignition chamber and the barrel shaped body and a discharge opening in the barrel shaped body lying substantially opposite the transition opening, the barrel shaped body having a wall thickness in the vicinity of the discharge opening and in the vicinity of the transition opening or of the region where the ignition chamber is attached is greater than the wall thickness of the remainder of the barrel shaped body, and to a method for producing such a combustion chamber.

### CROSS REFERENCE TO RELATED APPLICATIONS

This application is a continuation of international patent application no. PCT/DE2006/001579, filed Sep. 11, 2006, designating the United States of America and published in German on Mar. 22, 2007 as WO 2007/031057, the entire disclosure of which is incorporated herein by reference. Priority is claimed based on Federal Republic of Germany patent application nos. DE 10 2005 043 767.2, filed Sep. 13, 2005; DE 10 2006 008 581.7, filed Feb. 24, 2007, and DE 10 2006 034 285.2, filed Jul. 21, 2006.

### BACKGROUND OF THE INVENTION

The invention relates to a barrel shaped hollow body with a mounted ignition chamber with a connecting channel between the barrel shaped body and the ignition chamber. In this case the ignition chamber serves to receive an igniting medium, which following ignition enters into the combustion chamber and ignites the propellant, which is located in said combustion chamber. Then the propellant flows through the discharge apertures, which are affixed in a suitable manner in the barrel shaped body on the side that is situated opposite the ignition chamber.

This type of chamber must meet stringent requirements in terms of accuracy, in order to assure that the propellant will exit in as controlled a manner as possible into the airbag. This type of barrel shaped body is produced by cutting tubes to appropriate length and then sealing on both sides.

It has come to light that the combustion process and the discharge of the propellant into the airbag cause injuries. In a large percentage of these injuries the cause lies in the fact that at different points the propellant emerges with varying intensity—that is, not with the desired and targeted intensity—at the respective discharge apertures. It has even occurred that the combustion chambers have been ruptured due to the pressure of the propellant.

### SUMMARY OF THE INVENTION

The object of the present invention is to guarantee that the propellant will exit as uniformly as possible—i.e., exit in a controlled manner—from the corresponding discharge apertures of the combustion chamber. In addition, the invention makes possible a production that is as economical as possible, and the invention achieves a high quality, in particular strength, which is reliable with regard to the process.

This object is achieved by the invention in that the wall strength of the barrel shaped body is stronger in at least approximately the area of the discharge apertures and in the area of the transition aperture than in the rest of the area. This feature may be achieved, for example, by constructing the barrel shaped body so as to be reinforced in the area of the discharge apertures and in the area, in which the ignition chamber is mounted. For example, said barrel shaped body is reinforced in a manner analogous to an eyelet or by providing said barrel shaped body with a greater material thickness over at least approximately the length, over which the discharge apertures are arranged and/or the opposing area—thus, the area, in which the ignition chamber is mounted—in the barrel shaped body, over at least approximately the entire length. This may be done, for example, by constructing the inside cross section of the barrel shaped body elliptical and by constructing the outer contour circular. As a result, the shorter axis of the ellipse extends at least approximately through the area of the transition aperture and reaches up to the opposite area, on which or on both sides of which the discharge apertures are suitably arranged mirror-like over the length of the barrel shaped body.

The configuration may also be laid out in such a manner that the inside cross section is constructed in the shape of a circular ring and that the outer contour is constructed so as to be elliptical. Thus, the larger axis of the ellipse extends through the transition aperture up to the opposite area, in which—or on both sides of which—there are the discharge apertures. However, both contours—i.e., the inside cross section and/or the outer contour—may be constructed correspondingly elliptical.

Both the barrel shaped body and the ignition chamber may be manufactured especially advantageously and economically, if a sleeve shaped base body of the barrel shaped body and/or a similarly sleeve shaped base body of the ignition chamber is/are produced from a solid blank as a cold extruded part.

In this regard, in accordance with the rest of the invention, at least individual steps of the process steps listed in the description of the figures, may be suitable to produce the base bodies in an especially optimal manner.

Such components require a high and—above all—also uniform strength. For this reason, peel tests are carried out, inter alia, at random, in order to test the strength of the welded joint. It has been found that in many cases the peeling behavior was not adequate or that there were relatively large scatterings in the peel strength. In particular, it was shown that the weld peeled layer by layer. The reason was deemed to lie in the stretching of the material that was carried out to produce the sleeve and/or barrel shaped base body, as a result of which a longitudinally oriented laminar structure, which extends in the axial direction, and/or stretched grains are produced.

When welding on the parts, in particular during resistance welding (where capacitor discharge welding in which a high energy density is generated on relatively small areas has proven to be especially economical), it can happen that during the peel test a layer by layer peeling takes place at the weld.

In order to remedy these drawbacks, it has already been proposed to heat (i.e., temper) around the spot to be welded prior to the welding process. However, it has been found that this tempering offers only a partial improvement and that weld strength variations are still relatively large.

In addition, it has been proposed to carry out a second pulse—a so-called post impulse—following the welding process.

As a result, there was some improvement with regard to the tempering, but at the same time the cycling times of the machine increase significantly.

The object of an additional inventive idea is to avoid the above described drawbacks, in order to obtain a high welding quality (i.e. high peel strength at low cost) in not only this type of component, but also in others. This part of the invention relates not only to the parts that are described here and/or the method for producing the parts which are described here, but also relates to parts and/or methods for producing parts in general that are connected together by a welding process.

Accordingly, this inventive section relates to a method for producing products, where one component is welded together to another component. Of these two components at least one exhibits at least zones, which were subjected to a material stretching. This aspect of the invention is characterized in that prior to the welding process at least one of the components is heated in at least the area of the weld to be formed; and that the welding process takes place in the heated state. Therefore, it may be especially advantageous, if, in addition, prior to the welding process the workpiece that exhibits zones having laminar structure due to prior stretching is tempered or rather annealed at least in the area of the weld zone, in order to relieve stress at least at that zone.

As a result of this heating process directly before the welding process, during which the part still has a certain thermal capacity or amount of stored heat even during the welding process, when the part cools down, the effect of the ambient temperature on the weld or rather the immediate environment is decreased. That is, a certain thermal capacity remains over a prolonged period of time, so that the cooling process is retarded and enhanced internal stresses are avoided. In this way very high and stable peel strengths are achieved. Therefore, the critical cooling rate shall be retarded, and the formation of martensite shall be at least reduced.

In this respect it may be advantageous if only one of the components is heated; and, moreover, it may be especially advantageous if the component as a whole is heated. It may be advantageous if the heated component is the component that has the smaller mass. However, in other cases it may also be advantageous to heat the component that has the higher heat dissipation in the weld zone.

In this respect it may be especially practical to heat up to a value that avoids or reduces the formation of martensite during the cooling down process. Therefore, it is advantageous to provide heating up to a value, at which there is no oxidation or rather no tempering color arises that may have a deleterious effect on the subsequent welding operation.

Furthermore, it is advantageous to configure the heating process in such a manner that with respect to the formation of martensite during the cooling process, a critical cooling rate is undershot.

This additional heating of the weld zone or at least one of the components prior to the welding process may advantageously be carried out by inductive heating, but also by infrared heating in a process prior to the actual welding process, which does not have a negative impact on the machine cycling times, which are necessary for the welding process. It is advantageous for the heating to be carried out during the feed cycle in the welding tool. However, heating also may be carried out in a continuous furnace in front of the welding station.

### BRIEF DESCRIPTION OF THE DRAWINGS

The invention will be described in further detail hereinafter with reference to illustrative preferred embodiments shown in the accompanying drawing figures, in which:

FIG. 1 is a sectional view of the barrel shaped body of the combustion chamber with the ignition chamber welded to the body of the combustion chamber;

FIG. 2 is a schematic depiction of a blank or workpiece produced by cutting or sawing stock material;

FIG. 3 is a schematic representation of the workpiece after a setting or centering step;

FIG. 4 is a schematic representation of the workpiece after a first cupping step;

FIG. 5 is a schematic representation of the workpiece after a second cupping step;

FIG. 6 is a schematic representation of the workpiece after a drawing or pressing step;

FIG. 7 is a schematic representation of the workpiece after a rough turning step;

FIG. 8 is a schematic sectional view of the workpiece after a punching step;

FIG. 8a is a sectional view of the workpiece taken along line VIIIa-VIIIa of FIG. 8;

FIG. 8b is a sectional view of the workpiece taken along line VIIIb-VIIIb of FIG. 8a;

FIG. 9 is a schematic representation of the workpiece after a drilling or boring step, and

FIG. 10 is a schematic representation of the completed workpiece after a turning step.

### DETAILED DESCRIPTION OF PREFERRED EMBODIMENTS

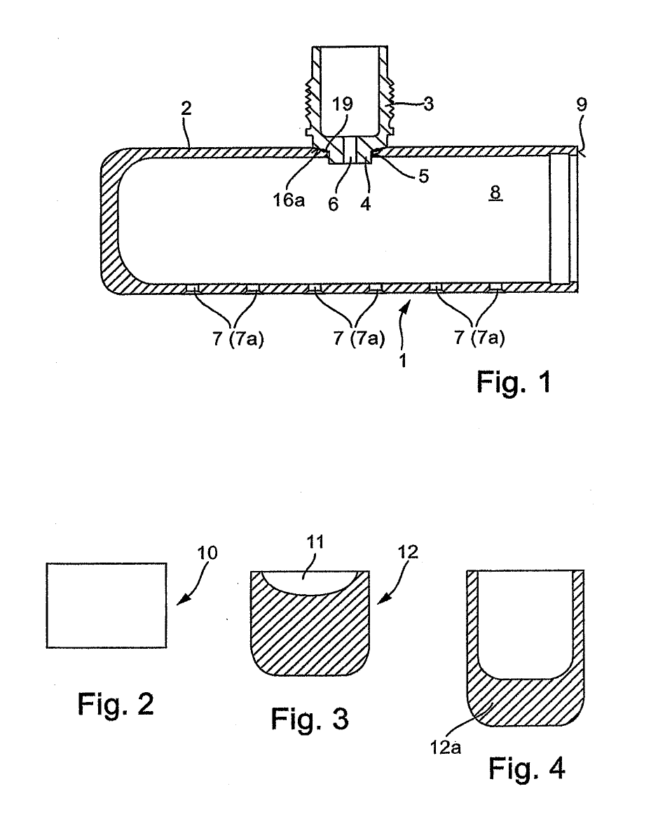

FIG. 1 shows that the combustion chamber 1 is comprised of a barrel shaped or rather sleeve shaped base body 2 with an ignition chamber 3, which is welded to said base body. The ignition chamber 3 is accommodated by inserting a neck 4 of the ignition chamber in a recess 5 of the sleeve body 2 and welding the parts together in this area. In addition, the ignition chamber 3 is provided with a transition aperture 6 and with a plurality of discharge apertures 7 (7a) on the opposite side from the transition aperture.

After the ignition chamber 3 is filled with the igniting medium and the hollow body 8 of the combustion chamber is filled with the propellant, the ignition chamber 3 is closed by means of a threaded connection, and the end face 9 of the combustion chamber is closed by welding on a cover.

In order to produce the sleeve shaped base body of the combustion chamber, the blank 10 as shown in FIG. 2 is cut to length, for example, sawed off, from bar stock.

In a subsequent working or process step, setting or centering is carried out to introduce or create a concentric recess 11 as shown in FIG. 3, which serves to center the punch for the subsequent working steps.

In the working step, according to FIG. 4, the so-called “first cupping” takes place in which a punch is pushed into the centering recess (11); and at the same time the material flows axially upwards, and in particular along the punch, producing a so-called “backward cup extrusion.” Therefore, the bottom, marked 12 in FIG. 3, is reduced in thickness, and the bottom 12a is formed, as depicted in FIG. 4.

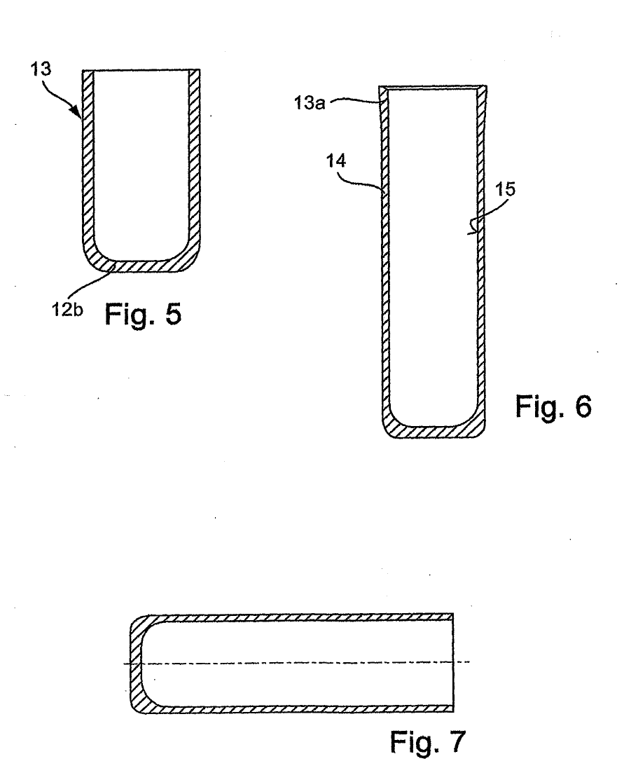

In the working step, depicted in FIG. 5, a “second cupping” takes place in which the bottom 12a of FIG. 4 is further reduced in thickness, and the bottom 12b, which corresponds at least approximately to the final dimension, is produced. In this working step the material of the bottom 12a is reduced, and the material is displaced backwards along an inserted extrusion punch.

Then a heat treatment is carried out. In particular, heating ensues up to a temperature so that at least approximately the initial microstructure is produced again. Due to this heat treatment a specific strength is also achieved with respect to the finished component; or rather through a suitable heat treatment and the degree of deformation in the subsequent processing step(s), the final strength of the component may be affected.

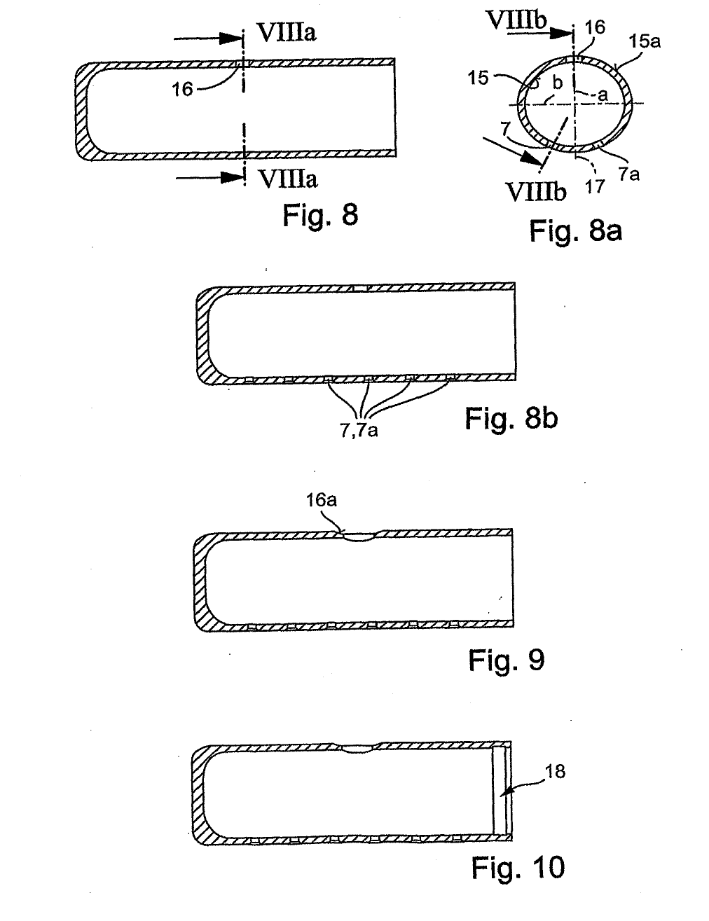

In the working step, according to FIG. 6, the bottom 12c is drawn and pressed, whereupon the conical area 13a—a so-called support area—also is formed, and the tubular or sleeve shaped region 13, depicted in FIG. 5, is elongated, and a sleeve shaped area 14 is produced. In this working step the oval and/or elliptical internal contour 15 is also produced (see also FIG. 8a).

In a subsequent process step, a rough turning operation takes place, during which the region 13a shown in FIG. 6 is cut down to produce the workpiece as shown in FIG. 7.

In the step according to FIGS. 8, 8a and 8b, where the latter two depict sectional views taken along the lines VIIIa-VIIIa and VIIIb-VIIIb of FIGS. 8 and 8a, a so-called punching takes place—that is, the formation of the apertures 16 for receiving the ignition chamber and the punching of the discharge apertures 7, 7a in the area generally opposite the aperture 16. In so doing, the apertures 16 as well as 7 and 7a are disposed opposite each other and/or the apertures 7, 7a are symmetrical to the central plane or central axis 17, which runs through the aperture 16 and between the two boreholes 7, 7a. The elliptical configuration 15 is laid out in such a manner that the elliptical axis a is shorter than the elliptical axis b. Thus, since the outer contour 15a has the shape of a circular ring, the area of the recess 16 as well as 7 and 7a retains a greater material strength.

In the working step, depicted in FIG. 9, the receiving borehole 16 is drilled or rather sunk, so that the result is a contour 16a at a relatively flat angle.

In a further step according to FIG. 10, the receiving contour 18 is turned for a cover, which is welded after the filling operation.

In another process step, as shown in FIG. 1, the ignition chamber 3 is welded onto the sunk contour 16a; and a weld bead 19 is formed. In this case it is especially advantageous to carry out the welding process, as described in the section preceding the description of the figures, in that the ignition chamber 3 is heated prior to the welding process, in particular a resistance welding process, such as a capacitor discharge welding process, and that the welding process takes place in the heated state of the ignition chamber. In this case the welding current may be introduced through the ignition chamber and may be conducted away through the sleeve body 2.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A combustion chamber comprising a barrel shaped body having an ignition chamber mounted thereon, a transition aperture between the ignition chamber and the barrel shaped body, and discharge apertures situated at least approximately opposite the transition aperture in the barrel shaped body, wherein the barrel shaped body has a greater wall strength in the region of the discharge apertures and in the region of the transition aperture or the region where the ignition chamber is attached than in the remainder of the barrel shaped body.

2. A combustion chamber as claimed in claim 1, wherein at least one of the outside diameter and the inside diameter of the barrel shaped body has an elliptical cross section such that a greater wall strength is provided adjacent the discharge apertures and in the region of the transition aperture or receiving aperture for the ignition chamber at least approximately along the longitudinal extent of the barrel shaped base body.

3. A combustion chamber as claimed in claim 1, wherein the barrel shaped body is cold extruded from a solid blank to obtain a sleeve shaped base body.

4. A method for producing a barrel shaped combustion chamber body with an attached ignition chamber, said method comprising:
a) cutting a workpiece to length from a stock material;
b) setting or centering the workpiece by forming a concentric recess or depression therein essentially by cold extrusion;
c) cupping the workpiece with an extrusion punch which penetrates deeper into the workpiece to form a bottom by cold extrusion, whereby the bottom is decreased in thickness;
d) further cupping the workpiece, whereby the bottom is further reduced in thickness and the cup shaped structure from step c) is enlarged by cold extrusion to form a deeper cup shape;
e) heat treating the workpiece to a temperature such that the workpiece at least approximately regains its initial microstructure;
) drawing the workpiece to form an elongated sleeve shaped region and pressing the bottom, whereby an area facing away from the bottom, is conically formed and a part of the conical area and the remainder of the workpiece are stretched, and whereby an elliptical cross sectional contour is produced in the interior or exterior of the workpiece or in both the interior and exterior of the workpiece;
g) turning the workpiece to cut away the conical area from step f);
h) punching a receiving aperture for the ignition chamber and a plurality of discharge apertures in the workpiece;
i) boring or countersinking the receiving aperture for the ignition chamber;
j) turning the open end of the workpiece to form a weld edge for welding a cover; and
k) attaching the ignition chamber to the combustion chamber.

5. A method as claimed in claim 4, wherein the ignition chamber is attached to the combustion chamber by capacitor discharge welding.

6. A method as claimed in claim 4, wherein the receiving aperture for the ignition chamber and the discharge apertures are punched in the same tool.

7. A method for producing a product comprising a component welded to a barrel shaped base body, wherein said component or said base body or both the component and the base body exhibit(s) zones subjected to a material stretching operation during formation thereof; said method comprising heating the component or the barrel shaped base body or both at least in the area to be welded prior to welding the component to the barrel shaped base body and then carrying out the welding with the component or the base body or both in the heated state.

8. A method as claimed in claim 7, wherein the component is welded to the barrel shaped base body by a resistance welding process in which a high energy density is generated on a relatively small surface.

9. A method as claimed in claim 7, wherein said barrel shaped base body is a combustion chamber, and said component is an ignition chamber welded to the combustion chamber.

10. A method as claimed in claim 7, wherein the component or the base body is heated as a whole.

11. A method as claimed in claim 7, wherein the heated part has a smaller mass than the other part.

12. A method as claimed in claim 7, wherein the heated part has exhibits a higher heat dissipation in the weld area than the other part.

13. A method as claimed in claim 7, wherein the heating is carried out to a temperature value such that formation of martensite during subsequent cooling is at least reduced.

14. A method as claimed in claim 7, wherein the heating is carried out to a temperature value below the oxidation limit of the heated part, whereby formation of tempering colors is avoided.

15. A method as claimed in claim 7, wherein the heating is carried out to a temperature value that falls below a critical cooling rate with respect to the formation of martensite.

16. A method as claimed in claim 7, wherein the heating prior to welding is carried out by inductive heating.

17. A method as claimed in claim 1, wherein the heating prior to welding is carried out in a continuous furnace in front of a welding station where the welding takes place.

18. A method as claimed in claim 7, wherein the heating is carried out during a feed cycle for feeding the component and barrel shaped base body to a welding tool for carrying out the welding.

19. A method as claimed in claim 7, wherein the component or the base body or both is tempered in the region of the weld to be formed prior to the welding.

20. A method as claimed in claim 4, wherein the ignition chamber or the barrel shaped combustion chamber or both is(are) tempered in the region of the weld to be formed prior to the welding.
